(19) United States
(12) Patent Application Publication
(10) Pub. No.: US 2024/0150179 A1
(43) Pub. Date: May 9, 2024

(54) PROCESS FOR PRODUCING GRAPHENE FROM GRAPHITE

(71) Applicant: Capattery Inc., Las Vegas, NV (US)

(72) Inventors: Susant Pattnaik, Bhubaneswar (IN); Aneeya Kumar Samantara, Bhogada (IN); Satyajit Ratha, Bhubaneswar (IN)

(21) Appl. No.: 18/483,783

(22) Filed: Oct. 10, 2023

(30) Foreign Application Priority Data
Aug. 18, 2023 (IN) 202341055600

(51) Int. Cl. C01B 32/19; C01B 32/196; C01B 32/225

(52) U.S. Cl. CPC C01B 32/19; C01B 32/196; C01B 32/225; C01B 2204/04; C01P 2006/80

(57) ABSTRACT

The present disclosure provides a process for producing graphene from graphite. The process includes mechanically agitating a first dispersion comprising graphite to form an exfoliated graphene dispersion. The exfoliated graphene dispersion is separated into a supernatant layer and a sediment layer. The supernatant layer comprises exfoliated graphene and the sediment layer comprises microstructured graphite. The process further comprises subjecting the supernatant layer to sonication to obtain a graphene dispersion. The graphene is obtained from the graphene dispersion by freeze drying.

### CROSS REFERENCE TO RELATED APPLICATIONS

This application claims priority benefit of Indian Application No. 202341055600, filed in the Indian Patent Office on Aug. 18, 2023. The above-referenced application is hereby incorporated herein by reference in its entirety.

### FIELD

Various embodiments of the disclosure relate generally to a process for producing graphene. More specifically, various embodiments of the disclosure relate to production of graphene from graphite and graphene produced therefrom.

### BACKGROUND

Graphene is composed of pure carbon and is utilized in various applications due to its unique characteristics. Graphene has a two-dimensional structure with carbon atoms positioned in a hexagonal pattern. A single layer of carbon atoms arranged in the hexagonal pattern forms a single graphene sheet whereas a multi-layered graphene is formed when several layers of carbon atoms are stacked one on top of the other. Typically, stacks of more than 30 layers are considered to be graphite which is a commonly occurring mineral.

Graphene is known for its excellent electronic and thermal properties and finds applications in electronics and energy sectors. High-quality graphene having fewer defects for electronics industry may be produced by chemical vapor deposition (CVD) and epitaxial growth techniques. However, both CVD and epitaxial growth techniques involve high costs and are time-intensive. Further, the yield from such techniques is quite low.

Conventional techniques may further utilize the scotch tape method to produce graphene with a large area or lateral dimension. The scotch tape method involves using adhesive tape to remove successive layers of graphite. However, the scotch tape method is time-consuming and not viable for large-scale production of graphene. The three-roll mill technique is a variation of the scotch tape method, where polyvinylchloride (PVC), dissolved in dioctylphthalate (DOP), acts as an adhesive to remove graphene from moving rolls of graphite. However, removal of residual PVC and DOP from the resulting graphene is tedious.

Industrial-scale graphene is produced by chemical methods that involve oxidation of graphite. The oxidation of graphite results in oxidized borders and basal planes of the graphite structure which on delamination or exfoliation yields graphene oxide. The graphene oxide is reduced to obtain single-layered graphene. However, the graphene obtained through such chemical methods may have oxygen-based functional groups. Additionally, there are challenges associated with the reduction process to obtain the desired purity level of graphene.

Yet another method to produce graphene is Liquid Phase Exfoliation (LPE) of graphite. LPE is typically performed under various conditions using techniques such as ball milling, ultrasonication, micro-fluidization, and high-shear mixing of graphite with a variety of liquids such as solvents, water, oil, ionic liquid, surfactants, and salts. The graphene formed as a dispersion in the respective liquid has to be separated from the dispersion. Even though the LPE method is viable for large-scale production, the operational time is longer and the quality of graphene produced is poor. Thus, to meet the ever-growing need for graphene, a scalable and cost-effective manufacturing process is required.

Limitations and disadvantages of conventional and traditional approaches will become apparent to one of skill in the art, through comparison of described systems with some aspects of the present disclosure, as set forth in the remainder of the present application and with reference to the drawings.

### BRIEF DESCRIPTION OF THE DRAWINGS

The accompanying drawings illustrate the various embodiments of systems, methods, computer program products, and other aspects of the disclosure. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa.

Various embodiments of the present disclosure are illustrated by way of example, and not limited by the appended figures, in which like references indicate similar elements:

FIG. 1 is a flow chart that illustrates a process for producing a graphene from graphite, in accordance with an exemplary embodiment of the disclosure.

Further areas of applicability of the present disclosure will become apparent from the detailed description provided hereinafter. It should be understood that the detailed description of exemplary embodiments is intended for illustration purposes only and is, therefore, not intended to necessarily limit the scope of the present disclosure.

### DETAILED DESCRIPTION

The following description illustrates some exemplary embodiments of the disclosed disclosure in detail. Those of skill in the art will recognize that there are numerous variations and modifications of this disclosure that are encompassed by its scope. Accordingly, the description of a certain exemplary embodiment should not be deemed to limit the scope of the present disclosure.

The term “comprising” as used herein is synonymous with “including,” or “containing,” and is inclusive or open-ended and does not exclude additional, unrecited elements, or process steps.

All numbers expressing quantities of ingredients, property measurements, and so forth used in the specification are to be understood as being modified in all instances by the term “about.” Accordingly, unless indicated to the contrary, the numerical parameters set forth herein are approximations that may vary depending upon the desired properties sought to be obtained.

Graphene can be described as a single-layer or multi-layered form of commonly found mineral graphite. Graphite is known for its low resistance to shear forces due to its layered structure and this property of graphite has been used in many techniques to extract graphene from graphite.

According to the embodiments of the present disclosure, a process for producing graphene from graphite is provided. The process comprises steps of (i) mechanically agitating a first dispersion comprising graphite in an impact chamber to form an exfoliated graphene dispersion. The process further comprises (ii) separating the exfoliated graphene dispersion from the impact chamber into a supernatant layer and a sediment layer. The supernatant layer comprises exfoliated graphene and the sediment layer comprises microstructured graphite. The process further comprises (iii) subjecting the supernatant layer to sonication to obtain a graphene dispersion at a temperature ranging from 5 degree Celsius (° C.) to −5° C. The process further comprises (iv) separating the graphene from the graphene dispersion by freeze drying.

In some embodiments, the step (i) of mechanically agitating the first dispersion comprises ball milling at a speed ranging from 200 revolutions per minute to 400 rpm for a time period ranging from 20 to 30 hours.

In some embodiments, the exfoliated graphene dispersion is separated by means of gravimetric separation. In yet another embodiment, the gravimetric separation comprises centrifuging the exfoliated graphene dispersion at a speed ranging from 8000 rpm to 10000 rpm for a time ranging from 20 minutes to 1 hour.

In some embodiments, the sediment layer is recycled by repeating the steps (i) to (iv).

In some embodiments, graphite of the step (i) is prepared by grinding and sieving raw graphite to a size of less than 50 microns. In another embodiment, the first dispersion is formed by dispersing graphite in a solvent with agitation.

In one embodiment, a graphene produced from graphite using a process is provided. The process comprises steps of (i) mechanically agitating a first dispersion comprising graphite in an impact chamber to form an exfoliated graphene dispersion. The process further comprises (ii) separating the exfoliated graphene dispersion from the impact chamber into a supernatant layer and a sediment layer. The supernatant layer comprises exfoliated graphene and the sediment layer comprises microstructured graphite. The process further comprises (iii) subjecting the supernatant layer to sonication to obtain a graphene dispersion at a temperature ranging from 5° C. to −5° C. The process further comprises (iv) separating the graphene from the graphene dispersion by freeze drying.

In some embodiments, the graphene has a thickness ranging from 3 to 5 atomic layers.

In some embodiments, the graphene has a lateral dimension ranging from 1 to 5 microns.

In some embodiments, the graphene has a carbon content of more than 99%.

These and other features and advantages of the present disclosure may be appreciated from a review of the following detailed description of the present disclosure, along with the accompanying figures in which like reference numerals refer to like parts throughout.

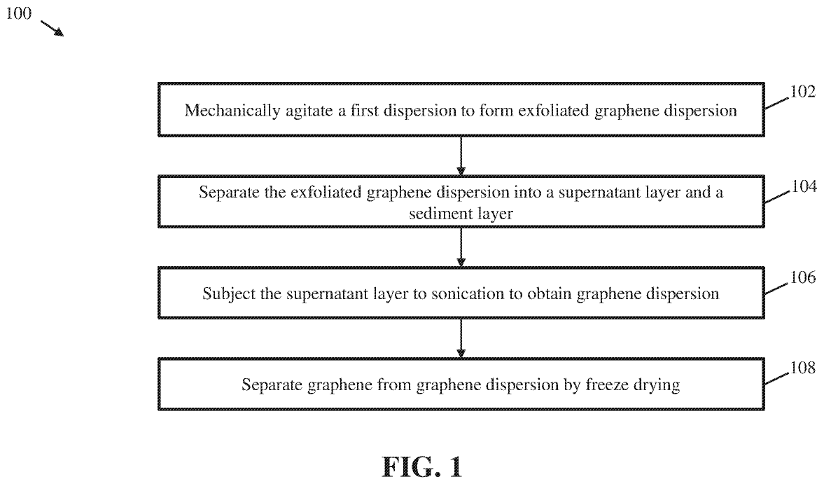

Embodiments of the present disclosure provide a process for producing a graphene from graphite. FIG. 1 is a flow chart 100 that illustrates the process for producing a graphene through exemplary steps 102 through 108 in accordance with an embodiment of the present disclosure. At step 102, a first dispersion comprising graphite is mechanically agitated in an impact chamber to form an exfoliated graphene dispersion.

Graphite of the step 102, is obtained from raw graphite. The raw graphite, in one embodiment, is natural graphite. In certain embodiments, the raw graphite is of synthetic origin. The raw graphite is ground and sieved to obtain graphite having uniform particle size. In one embodiment, graphite has a particle size of less than 50 microns (μm). In another embodiment, the particle size of graphite is in a range of 25 μm to 50 μm.

Graphite is dispersed in a suitable solvent to form the first dispersion. Examples of the solvent include, but are not limited to, N, N-dimethylformamide (DMF), N-methylpyrrolidone (NMP), N,N-dimethyl acetamide (DMA), gamma-butyrolactone, dimethylsulfoxide (DMSO), 1,3-dimethyl-2-imidazolidinone, or any combinations thereof. In one embodiment, the solvent is DMF. According to embodiments of the present disclosure, the solvent is selected such that they form favorable interaction with graphite whereby the weak van der Waal's forces between graphite layers are disrupted. Additionally, the freezing point of the solvent is considered while selecting the solvent, and will be discussed further at step 108.

In one embodiment, graphite is mixed with the solvent to form a graphite solution which under agitation forms the first dispersion. In one embodiment, agitation is achieved by ultrasonicating the graphite solution. Other techniques such as centrifugation, magnetic stirring may be utilized to form the first dispersion. The formation of the first dispersion may be at room temperature or at elevated temperatures to enhance the formation of the first dispersion.

Graphite is present in the first dispersion in an amount ranging from 10 milligrams per milliliter (mg/mL) to 175 mg/mL. In one embodiment, graphite is present in the first dispersion in an amount ranging from 60 mg/mL to 100 mg/mL.

The first dispersion is introduced in the impact chamber for mechanical agitation to form the exfoliated graphene dispersion. The mechanical agitation is performed by optimizing the forces, namely, normal forces and shearing forces, experienced by graphite in the impact chamber. As will be appreciated, the normal forces are responsible for breaking graphite into smaller graphite components while the shearing forces are responsible for delamination of graphite layers or exfoliation of graphite. The mechanical agitation helps in exfoliating graphite by reducing the weak van der Waal's forces of attraction holding graphite layers together. The exfoliation of graphite is also aided by favorable interactions between the solvent and graphite molecules. Further, through mechanical agitation, graphite is broken down into smaller graphite components. In one embodiment, the mechanical agitation is performed by means of a ball mill. In embodiments, where mechanical agitation is performed by ball milling, the impact chamber is the ball mill. In a ball mill, the forces for mechanical agitation depend on many factors such as size of the ball mill, amount of sample material introduced in the ball mill, nature of the sample material, temperature, type, and number of balls as well as speed of rotational motion of the mill. In one embodiment, shearing forces within the impact chamber and/or the ball mill are transferred by means of ferromagnetic and/or paramagnetic balls.

In one embodiment, the rotational motion is at a speed in a range of 200 rpm to 400 rpm. In another embodiment, the rotational speed is at 300 rpm. In one embodiment, the ball milling is performed for a time period of less than 30 hours. In another embodiment, the ball milling is performed for a time period in a range of 15 to 25 hours.

At step 104, the exfoliated graphene dispersion is separated into a supernatant layer and a sediment layer. The supernatant layer comprises exfoliated graphene and the sediment layer comprises microstructured graphite. As used herein, the term “exfoliated graphene” refers to a graphene where the interlayer attraction between layers of graphite is weakened and may be considered a precursor to the graphene. As used herein, the term “microstructured graphite” refers to graphite having more than 20 layers of graphene. In one embodiment, the exfoliated graphene dispersion is separated by means of gravimetric separation. In gravimetric separation, components of the exfoliated graphene dispersion, namely, the exfoliated graphene and the microstructured graphite, are separated due to their differences in weight and/or density. In one embodiment, the gravimetric separation is achieved by centrifuging the exfoliated graphene dispersion. The centrifugation is performed for a time period in a range of 20 minutes to 1 hour and at a speed in a range of 7000 to 11000 rpm. In one embodiment, centrifugation is performed for a time period in a range of 20 minutes to 1 hour and at a speed in a range of 8000 to 10000 rpm. In yet another embodiment, the centrifugation is performed for a time period of 30 minutes and at a speed of 9000 rpm. According to embodiments of the disclosure, the speed and the time period of centrifugation can be optimized so as to prevent fragmentation of graphite to form the graphene having a desirable lateral dimension.

In an embodiment of the disclosure, the sediment layer obtained at step 104 is recycled by repeating steps 102 to 108. A particular advantage of the disclosure is the recycling of the sediment layer thus extracting maximum graphite for conversion to the graphene and thereby increasing the overall yield of the process.

At step 106, the supernatant layer is subjected to sonication to obtain a graphene dispersion at a temperature ranging from 5 degree Celsius (° C.) to −5° C. As will be appreciated, sonication helps in separating and stabilizing individual graphene molecules in the graphene dispersion.

At step 108, the graphene is separated from the graphene dispersion by freeze drying. In freeze drying, the solvent freezes at a temperature corresponding to the freezing temperature of the solvent, and the temperature is further lowered such that sublimation of the solvent takes place instead of melting while leaving the graphene in dry form. The step 108, of freeze drying is critical to preserve layered structure of the graphene and prevents any agglomeration of individual graphene molecules.

The solvent in addition to having favorable interaction with graphite molecule can be chosen such that attaining the freezing temperature requires lower energy input. For example, DMF has a freezing temperature of −61° C. and would require lower energy for freeze drying when compared to acetone which has a freezing temperature of −94° C.

A particular advantage of the disclosure is the reuse of the solvent obtained at step 108. Reusing or recycling the solvent advantageously makes the process economical in addition to being environment friendly. Unlike other known methods of production of graphene from graphite, the graphene obtained according to embodiments of the present disclosure is devoid of any impurities and residual solvent.

The process described in conjunction with FIG. 1, can be performed as a continuous process, semi-continuous process, or as a batch process. The process does not require any surfactant, nor any additional catalysts and/or solvents, and is scalable to produce a few layers of (<5 layers) graphene. The graphene produced according to embodiments of the present disclosure has a thickness ranging from 3 to 5 atomic layers. The graphene produced according to embodiments of the present disclosure has a lateral dimension ranging from 1 to 5 microns. In another embodiment, the graphene has a lateral dimension ranging from 1 to 3 microns. The graphene produced according to embodiments of the present disclosure has a carbon content of more than 99%.

The overall yield of the graphene produced according to embodiments of the present disclosure is more than 45%. In one embodiment, the overall yield of the graphene produced from the process is in a range of 45% to 60%. The steps 102 to 108, and the processing parameters such as time period, and mixing speed have been instrumental in achieving the obtained yield and purity of the graphene product.

The below example has been provided for the preparation of graphene:

Natural graphite was ground and sieved to achieve a uniform particle size of less than 50μ. About 20 grams (g) of ground graphite was dispersed in 100 milliliters (ml) of anhydrous N, N-dimethylformamide (DMF) solvent by ultrasonication for about 30 minutes. The graphite dispersion was then transferred to a ball mill generating centrifugal force and having ferromagnetic and paramagnetic spherical balls to generate optimum amount of normal force. The graphite dispersion was subjected to both shearing and normal forces in the ball mill for about 20 to 30 hours at 300 rpm, with 10:1 ball to material ratio to form graphene dispersion. The graphene dispersion was then centrifuged at high rpm (˜9000 rpm) for about 30 minutes to obtain the supernatant layer and the sediment layer. The supernatant layer containing exfoliated graphene was ultrasonicated using probe sonicator for 30 minutes under an ice bath. A magnetic stirrer was used to maintain the moving cavitation field during ultrasonication. After ultrasonication, the exfoliated graphene was subjected to freeze drying to remove DMF. After freeze drying, the graphene was collected in powder form and stored. The graphene produced was tested and characterized. The bulk density of the graphene was found to be 0.08 grams per cubic centimeter (g/cc) and it had a surface area of 540 square meter per gram (m2/g).

The lateral dimension and the thickness of the graphene were obtained from Field emission scanning electron microscopy (FE-SEM). The lateral dimension of the graphene was found to be less than 5 microns. The graphene was found to be of 2 to 5 layers and had a thickness of 1-3 nm. High-resolution transmission electron microscopy (TEM) of the graphene revealed the transparent nature of the graphene that was produced. Raman spectra of the graphene showed one small peak (D-band) along with a sharp and highly intense peak (G band) confirming the purity of the graphene produced. X-ray photoelectron spectra of the graphene showed sharp and intense peak at binding energy of 284 nm thus confirming the purity and high carbon content of the graphene. The purity of the graphene was found to be more than 99% with a carbon ash content of less than 0.001%.

It is to be understood that the above description is intended to be illustrative, and not restrictive. Furthermore, many other embodiments will be apparent to those of skill in the art upon reading and understanding the above description. Although the present disclosure has been described with reference to specific exemplary embodiments, it will be recognized that the disclosure is not limited to the embodiments described, but can be practiced with modification and alteration within the scope of the appended claims.

What is claimed is:

1. A process for producing graphene from graphite comprising steps of:
(i) mechanically agitating a first dispersion comprising graphite in an impact chamber to form an exfoliated graphene dispersion;
(ii) separating the exfoliated graphene dispersion from the impact chamber into a supernatant layer and a sediment layer, wherein the supernatant layer comprises exfoliated graphene and the sediment layer comprises microstructured graphite;
(iii) subjecting the supernatant layer to sonication to obtain a graphene dispersion at a temperature ranging from 5 degree Celsius (° C.) to −5° C.; and
(iv) separating the graphene from the graphene dispersion by freeze drying.

2. The process as claimed in claim 1, wherein the sediment layer is recycled by repeating the steps (i) to (iv).

3. The process as claimed in claim 1, wherein graphite of the step (i) is prepared by grinding and sieving raw graphite to a size of less than 50 microns.

4. The process as claimed in claim 3, wherein the first dispersion is formed by dispersing graphite in a solvent with agitation.

5. The process as claimed in claim 4, wherein the solvent comprises N,N-dimethylformamide (DMF), N-methylpyrrolidone (NMP), N,N-dimethyl acetamide (DMA), gamma-butyrolactone, dimethylsulfoxide (DMSO), 1,3-dimethyl-2-imidazolidinone, or any combinations thereof.

6. The process as claimed in claim 1, wherein the step (i) of mechanically agitating the first dispersion comprises ball milling at a speed ranging from 200 revolutions per minute (rpm) to 400 rpm for a time period ranging from 20 to 30 hours.

7. The process as claimed in claim 1, wherein the exfoliated graphene dispersion is separated by means of gravimetric separation.

8. The process as claimed in claim 7, wherein the gravimetric separation comprises centrifuging the exfoliated graphene dispersion at a speed ranging from 8000 revolutions per minute (rpm) to 10000 rpm for a time ranging from 20 minutes to 1 hour.

9. The process as claimed in claim 1, wherein the process is a batch process, a continuous process, or a semi-continuous process.

10. The process as claimed in claim 1, wherein the graphene has a thickness ranging from 3 to 5 atomic layers.

11. The process as claimed in claim 1, wherein the graphene has a lateral dimension ranging from 1 to 5 microns.

12. The process as claimed in claim 1, wherein the graphene has a carbon content of more than 99%.

13. A graphene produced from graphite using a process comprising:
(i) mechanically agitating a first dispersion comprising graphite in an impact chamber to form an exfoliated graphene dispersion;
(ii) separating the exfoliated graphene dispersion from the impact chamber into a supernatant layer and a sediment layer, wherein the supernatant layer comprises exfoliated graphene and the sediment layer comprises microstructured graphite;
(iii) subjecting the supernatant layer to sonication to obtain a graphene dispersion at a temperature ranging from 5° C. to −5° C.; and
(iv) separating the graphene from the graphene dispersion by freeze drying.

14. The graphene as claimed in claim 13, wherein the graphene has a carbon content of more than 99%.

15. The graphene as claimed in claim 13, wherein the graphene has a thickness ranging from 3 to 5 atomic layers.

16. The graphene as claimed in claim 13, wherein the graphene has a lateral dimension ranging from 1 to 5 microns.
